(19) United States
(12) Patent Application Publication
(10) Pub. No.: US 2005/0061033 A1
(43) Pub. Date: Mar. 24, 2005

(54) Method of making amber glass composition having low thermal expansion

(76) Inventors: Valeria Greco Petrany, Glassboro, NJ (US); David M. Watson, Vineland, NJ (US); John Patrick McDermott, Mauricetown, NJ (US)

Correspondence Address: RATNERPRESTIA, P O BOX 980, VALLEY FORGE, PA, 19482-0980, US

(21) Appl. No.: 10/851,537

(22) Filed: May 21, 2004

Related U.S. Application Data
(60) Provisional application No. 60/476,034, filed on Jun. 5, 2003.
(60) Provisional application No. 60/476,158, filed on Jun. 5, 2003.

(51) Int. Cl. C03C 3/091; C03C 3/093

(52) U.S. Cl. 65/134.9; 501/66; 501/67

(57) ABSTRACT

A method of making an amber borosilicate glass having a thermal expansion coefficient which ranges from 29×10⁻⁷ cm/cm/° C. to 48×10⁻⁷ cm/cm/°C. having the steps of: forming a substantially homogeneous melt comprising, in weight %, 70.0-80.0% SiO₂; 10.0-15.0% B₂O₃; 1.0-5.0% Al₂O₃; 0.0-7.0% Na₂O; 0.0-8.0% K₂O; 0.1-2.0% Fe₂O₃; 0.1-5.0% TiO₂; 0.0-4.0% CaO; 0.0-4.0% MgO; 0.0-4.0% BaO and SrO combined; 0.0-1.0% ZnO; 0.0-1.0% Cl₂; 0.0-1.0% F₂; and 0.0-1.0% ZrO₂; refining the melt to remove substantially all gas bubbles from the melt; and cooling the melt to form amber glass. The amber glass formed according to the method of the present invention meets both the hydrolytic resistance requirements and light protection requirements for Type I glass in accordance with USP containers.

This application is related to and claims the benefit of U.S. Provisional Application No. 60/476,034 entitled METHOD OF MAKING AMBER GLASS COMPOSITION HAVING LOW THERMAL EXPANSION filed on Jun. 5, 2003 and U.S. Provisional Application No. 60/476,158 entitled AMBER GLASS COMPOSITION filed on Jun. 5, 2003.

### FIELD OF THE INVENTION

The invention relates to a method of making a USP Type I, amber glass compositions having low thermal expansion coefficients.

### BACKGROUND OF THE INVENTION

Certain products require packaging in a container that provides a high degree of chemical stability and protection from ultraviolet light. Such products typically include pharmaceuticals. Known packaging for pharmaceuticals in need of chemical stability includes glasses known as Type I glasses. These glasses are often formed into tubes and then made into individual vials or ampules. Most Type I tubing vials and ampules are fabricated from a borosilicate glass.

It is also desirous in the case of such sensitive materials as pharmaceuticals to prevent the passage of ultraviolet light. This also aids in the preservation of the packaged material. A common ultraviolet absorbing glass is an amber colored glass. Several coloring schemes are known in the prior art to achieve amber coloring of Type I glasses. These include borosilicate glasses colored by either an iron-manganese system or an iron-titanium coloring system. The borosilicate glasses utilizing an iron-manganese coloring system have been found to have a thermal expansion coefficient of about 37×10⁻⁷ cm/cm/° C. The iron-titanium coloring system glasses that meet both chemical durability and ultraviolet light protection requirements have thermal expansion coefficients of approximately 57×10⁻⁷ cm/cm/° C. Because of this relatively high thermal expansion coefficient of this later amber tubing, however, vials and ampules fabricated from such tubing glasses are prone to cracking.

Fabrication cracks are very difficult to detect during inspection. The cracks are a problem for drug manufacturers due to breakage and loss of sterility. Such cracks are produced when temperature differences (gradients) in the tubing cause high levels of stress to develop due to the high thermal expansion. Decreasing the thermal expansion would minimize the incidence of these cracks.

Another problem has been seen with the iron-manganese colored glasses of the prior art. Some of these have shown inconsistency or instability of coloring during manufacturing. Thus, color stability and low thermal expansion have been a trade-off. These competing factors, the first favored by an iron-titanium system, and the second favored by an iron-manganese system, have not before been reconciled.

One known tubing container has been sold by Wheaton Science Products under glass code “320”. This particular glass has an iron-titanium coloring system, with composition values of 70 wt % SiO₂, 6 wt % Al₂O₃, 8 wt % Na₂O+K₂O, 0.5 wt % CaO+MgO, 7 wt % B₂O₃, 2 wt % BaO, 5 wt % TiO₂, 1.5 wt % Fe₂O₃. This glass has a thermal expansion coefficient of 55×10⁻⁷ cm/cm/° C. meets USP hydrolytic resistance requirements for Type I, and meets USP requirements for light protection.

Thus, an improved amber glass would incorporate low thermal expansion, provide adequate ultraviolet filtration, exhibit high hydrolytic resistance, provide increased color stability, all while utilizing an iron-titanium coloring system.

### SUMMARY OF THE INVENTION

The present invention is a method of making an amber borosilicate glass having a thermal expansion coefficient which ranges from 29×10⁻⁷ cm/cm/° C. to 48×10⁻⁷ cm/cm/° C. The method comprises the steps of forming a substantially homogeneous melt consisting of, in weight %, 70.0-80.0% SiO₂; 10.0-15.0% B₂O₃; 1.0-5.0% Al₂O₃; 0.0-7.0% Na₂O; 0.0-8.0% K₂O; 0.1-2.0% Fe₂O₃; 0.1-5.0% TiO₂; 0.0-4.0% CaO; 0.0-4.0% MgO; 0.0-4.0% BaO and SrO combined; 0.0-1.0% ZnO; 0.0-1.0% Cl₂; 0.0-1.0% F₂; and 0.0-1.0% ZrO₂, refining the melt to remove substantially all gas bubbles from the melt, and cooling the melt to form amber glass. The amber glass formed according to the method of the present invention meets both the hydrolytic resistance requirements and light protection requirements for Type I glass in accordance with USP containers.

A preferred glass composition made in accordance with the present invention consists of, in weight %, 73.0-79.0% SiO₂; 11.0-13.0% B₂O₃; 3.0-5.0% Al₂O₃; 2.0-3.8% Na₂O; 0.0-2.0% K₂O; 1.0-1.5% Fe₂O₃; 0.5-3.0% TiO₂; 0.0-1.0% CaO; 0.0-1.0% MgO; 0.0-2.0% BaO and SrO combined; 0.0-0.5% ZnO; 0.0-0.5% Cl₂; 0.0-0.5% F₂; and 0.0-0.5% ZrO₂.

A more preferred glass composition made in accordance with the present invention consists of, in weight %, 76.0-78.0% SiO₂; 11.5-12.5% B₂O₃; 3.0-4.0% Al₂O₃; 3.0-3.7% Na₂O; 0.0-1.0% K₂O; 1.0-1.5% Fe₂O₃; 1.5-2.5% TiO₂; 0.2-0.8% CaO; 0.0-0.2% MgO; 0.0-0.2% Cl₂; 0.0-0.2% F₂; and 0.0-0.2% ZrO₂.

The most preferred glass composition made in accordance with the present invention consists of, in weight %, 76.7% SiO₂; 11.7% B₂O₃; 3.2% Al₂O₃; 3.7% Na₂O; 0.6% K₂O; 1.2% Fe₂O₃; 2.1% TiO₂; 0.4% CaO; 0.1% Cl₂; and 0.1% F₂.

### DETAILED DESCRIPTION

The invention relates to method of making a borosilicate amber glass which has an iron-titanium based coloring system, low thermal expansion and high hydrolytic resistance. The amber borosilicate glass made in accordance with the present invention has a thermal expansion coefficient of approximately 29×10⁻⁷ cm/cm/° C. to 48×10⁻⁷ cm/cm/° C., and meets both the hydrolytic resistance requirements and light protection requirements for Type I glass in accordance with USP containers. The amber borosilicate glass made in accordance with the present invention comprises, in weight percent: 70.0-80.0% SiO₂; 10.0-15.0% B₂O₃; 1.0-5.0% Al₂O₃; 0.0-7.0% Na₂O; 0.0-8.0% K₂O; 0.1-2.0% Fe₂O₃; 0.1-5.0% TiO₂; 0.0-4.0% CaO; 0.0-4.0% MgO; 0.0-4.0% BaO and SrO combined; 0.0-1.0% ZnO; 0.0-1.0% Cl₂; 0.0-1.0% F₂; and 0.0-1.0% ZrO₂.

The glass made in accordance with the present invention is an alternate material for those who package pharmaceutical products in Type I amber blow molded containers manufactured in Europe and USP Type I amber tubing containers. The glass product of the present invention exhibits both a thermal expansion coefficient significantly lower than commercially available Type I amber glass, while utilizing an iron-titania coloring system otherwise consistent with the formulation of commercially available Type I amber tubing containers and European Type I amber molded containers.

The combination of these characteristics offers a double benefit to the pharmaceutical packager. The first is reduced potential for glass cracking during component fabrication and pharmaceutical processing because of the relatively low thermal expansion coefficient. The second is a reduced potential for unexpected product-package interactions that could arise if an alternate coloring system, such as iron-manganese, were used. Prior to this invention, the combination of these two characteristics in a USP Type I amber glass did not exist.

Another advantage of the glass product of the present invention is that it will have its barrier to market entry significantly reduced because its base formula is otherwise consistent with materials currently in use. This is because no new elements are introduced to the product—package system, which significantly reduces the potential for an adverse reaction between the product and the container. For example, some drug products are stable in an iron-titania amber, but form a precipitate when packaged in an iron-manganese amber. If a new material is introduced to the market that contains the same base elements as the current container but has improved physical properties, it has a better chance of being commercially accepted. This is because the likelihood of product incompatibility attributable to the introduction of new elements is eliminated.

Prior art pertaining to the manufacture of a low thermal expansion USP Type I amber tubing glass has focused on iron-manganese coloring systems. One example of such an iron-manganese coloring system is found in U.S. Pat. No. 5,258,336. This patent discloses a glass formulation that has a thermal expansion coefficient of 37×10⁻⁷−42×10⁻⁷ cm/cm/° C. and imparts color to the glass using a combination of 0.35 wt % Fe₂O₃ and 6 wt % MnO₂. The possibility of using an iron-titanium coloring system is also referenced in this patent, however, no description is provided about how this might be achieved and it is unclear whether such system would also contain MnO₂. Although this glass does offer the improved crack resistance associated with lower thermal expansion, it utilizes elements that are not present in commercially available Type I amber tubing containers and European Type I amber molded containers. The chemical composition of the present invention which uses the iron—titanium coloring system is consistent with currently marketed tubing products.

Product protection and safe package requirements for pharmaceutical containers translate to sterility protection and ability to remain intact on the filling line and in the field. Cracks are a common glass defect detrimental to both of these concerns. The material properties that significantly influence the probability of creating cracks during vial fabrication and pharmaceutical processing are the thermal expansion characteristics and the elastic properties. With all other conditions being equal, materials with a higher thermal expansion coefficient and a higher elastic modulus will inherently experience higher stress for the same conditions and applied loads. This higher stress equates to a higher failure probability. This is illustrated by the following calculations. For simplicity, throughout the derivation geometric effects have been disregarded.

The change in length of an object is proportional to the thermal expansion coefficient and the change in temperature: ΔL=α*L*ΔT, where α=thermal expansion coefficient, L=length of the object and T=temperature. The stress experienced in a material is a function of the strain deformation and the elastic modulus: σ=E*ε, where σ=stress, E=elastic modulus and ε=strain. For a given temperature change, assuming that the strain deformation, ε, is equivalent to the change in length, ΔL, it is derived that, given the same conditions, the ratio of the stresses in the two materials will be proportional to the ratio of the thermal expansion coefficients and elastic moduli: σ₁=σ₂(α₁ * E₁)/(α₂ * E₂). The material properties for the present invention (pi) versus commercially available prior art (pa) shows that the thermal stress in the prior art will be 1.54 times higher. The property values used in the calculation are: Eₚₐ=58 GPa; Eₚᵢ=53 GPa; αₚₐ=55×10⁻⁷ cm/cm/° C.; αₚᵢ=39×10⁻⁷ cm/cm/° C.

In a silicate glass the network bonds are very strong, and the theoretical stress needed to fracture the material is on the order of 2 GPa. Small flaws that exist in the glass concentrate applied stresses, thus permitting the critical stress to be reached when the applied stress is far less than 2 GPa. The statistical distribution of these flaws controls the distribution of glass failure strength, and the glass failure strength conforms to a Weibull distribution:

$$CFP = 1 - {ⅇ}^{- {( \frac{x}{β} )}^{α}}$$

Where CFP is the cumulative probability of failure, x is the applied stress, β is the geometric mean strength of the glass, and α is the Weibull modulus. Weibull parameters used to represent the failure rates of tubing containers reflect the high level of performance expected for the pristine, fire polished surfaces, and for this illustration were chosen to be β=250 MPa and α=5. Continuing the illustration, a 4 cm length of glass experiencing a 50° C. temperature change as can be experienced during ice crystallization during freeze drying, would have a failure probability of approximately 1 in 810,000,000 for the present invention, and 1 in 60,000 for the prior art. An applied thermal load created by a 190° C. temperature change, similar to placing a vial directly into a hot oven, generates approximately 15.8 MPa stress in the present invention, corresponding to an approximate failure probability of 1 in 1,000,000. For the prior art the same applied load would generate 24.3 MPa stress, corresponding to an approximate failure probability of 1 in 1,000. It is clearly demonstrated that the present invention offers improved fracture resistance in comparison to commercially available Type I amber tubing glass.

Table I below sets forth the ingredients of the borosilicate amber glass composition made by the method of the present invention and the percent weight of each ingredient.

TABLE 1

| | | | Most |
|---|---|---|---|
| Oxide | Range | Preferred Range | Preferred Range |
| SiO₂ (wt %) | 70.0-80.0 | 73.0-79.0 | 76.0-78.0 |
| B₂O₃ (wt %) | 10.0-15.0 | 11.0-13.0 | 11.5-12.5 |
| Al₂O₃ (wt %) | 1.0-5.0 | 3.0-5.0 | 3.0-4.0 |
| Na₂O (wt %) | 0.0-7.0 | 2.0-3.8 | 3.0-3.7 |
| K₂O (wt %) | 0.0-8.0 | 0.0-2.0 | 0.0-1.0 |
| Fe₂O₃ (wt %) | 0.1-2.0 | 1.0-1.5 | 1.0-1.5 |
| TiO₂ (wt %) | 0.1-5.0 | 0.5-3.0 | 1.5-2.5 |
| CaO (wt %) | 0.0-4.0 | 0.0-1.0 | 0.2-0.8 |
| MgO (wt %) | 0.0-4.0 | 0.0-1.0 | 0.0-0.2 |
| BaO + SrO (wt %) | 0.0-4.0 | 0.0-2.0 | 0 |
| ZnO (wt %) | 0.0-1.0 | 0.0-0.5 | 0 |
| Cl₂ (wt %) | 0.0-1.0 | 0.0-0.5 | 0.0-0.2 |
| F₂ (wt %) | 0.0-1.0 | 0.0-0.5 | 0.0-0.2 |
| ZrO₂ (wt %) | 0.0-1.0 | 0.0-0.5 | 0.0-0.2 |

The most preferred glass composition made by the method of the present invention consists of, in weight percent, 76.7% SiO₂; 11.7% B₂O₃; 3.2% Al₂O₃; 3.7%. Na₂O; 0.6% K₂O; 1.2% Fe₂O₃; 2.1% TiO₂; 0.4% CaO; 0.1% Cl₂; and 0.1% F₂. Although potassium oxide and sodium oxide have a lower limits of zero, the total desired amount of these two combined is from 3.7 wt % to about 4.0 wt %. Similarly, although CaO and MgO are both shown as having lower limits of zero, a total of about 0.4 wt % is desired for these two components in combination, with 0.4 wt % CaO and no MgO being most preferred. Also, the halogens, Cl₂ and F₂, are both shown as having a bottom limit of zero, but a total of about 0.2 wt % of these two combined is preferred, with 0.1 wt % of each being most preferred.

Silica and boron are the primary glass network formers, and produce a glass matrix that has a low thermal expansion coefficient and high hydrolytic resistance. The alkali oxides of sodium and potassium are glass network modifiers that result in a viscosity curve that allows melting, forming and secondary fabrication with conventional glass processes. In addition, the low alkali content contributes to the low thermal expansion and high hydrolytic resistance of the glass. The aluminum oxide improves the chemical durability of the glass and helps prevent devitrification and phase separation. The iron and titanium combination serves as the amber colorant system and imparts light absorbing properties to the glass product of the present method.

Small amounts of refining agents, viscosity aides, and re-dox adjusters such as chlorides, fluorides, nitrates and carbons may be added to aid in bubble removal and to optimize glass quality and color. These agents may present themselves in the glass composition as minor amounts of alkaline earth oxides (calcia, magnesia, baria, strontia), chlorides and fluorides. Zinc oxide may be added to suppress phase separation that may accompany prolonged heat-treats. Zirconia may be added for improved chemical durability, but can cause opacification of the glass during secondary heat treatments.

Raw materials used in this invention should be glass grade materials. Typical choices could be, but are not limited to, glass grade sands, borax or boric acid, alkali carbonates, alumina, iron oxide frit (pelletized iron oxide with fluxing agents), titanium dioxide and fluorspar. Cullet of compatible composition may be used. Material selection should be made based on available materials and the performance of the glass in the manufacturing unit. Where possible, iron oxide should be introduced into the batch in its reduced form to minimize refining time by lessening the potential for producing small gaseous inclusions in the glass.

The following examples presented in Table 2 illustrate the practice of the present invention but are not intended to indicate the limits of the scope thereof. The thermal expansion ranges shown by the glass product examples made from this method offer a reduction of about 24%-38% over the non-manganese colored tubing glasses of the prior art.

TABLE 2

| | Example: | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| SiO₂ | 76.7 | 76.0 | 76.9 | 76.7 | 78.0 | 76.5 | 75.8 | 73.0 | 73.9 | 79.0 | 73.9 | 78.2 |
| (wt %) | | | | | | | | | | | | |
| B₂O₃ | 11.7 | 12.5 | 12.5 | 11.5 | 11.5 | 11.0 | 11.0 | 13.0 | 11.1 | 11.0 | 11.1 | 13.6 |
| (wt %) | | | | | | | | | | | | |
| Al₂O₃ | 3.2 | 4.0 | 3.5 | 3.0 | 3.0 | 5.0 | 5.0 | 4.0 | 4.0 | 3.0 | 4.0 | 2.0 |
| (wt %) | | | | | | | | | | | | |
| Na₂O | 3.7 | 3.0 | 4.6 | 3.8 | 3.8 | 3.0 | 3.0 | 2.0 | 3.8 | 3.8 | 3.8 | 4.0 |
| (wt %) | | | | | | | | | | | | |
| K₂O | 0.6 | 1.0 | 0.2 | 0.5 | 0.0 | 0.0 | 0.0 | 2.0 | 2.0 | 1.0 | 2.0 | 0.0 |
| (wt %) | | | | | | | | | | | | |
| Fe₂O₃ | 1.2 | 1.2 | 0.8 | 1.5 | 1.0 | 1.0 | 1.0 | 1.3 | 1.5 | 1.0 | 1.5 | 0.5 |
| (wt %) | | | | | | | | | | | | |
| TiO₂ | 2.1 | 1.5 | 0.9 | 2.5 | 1.7 | 1.5 | 1.5 | 3.0 | 2.5 | 0.5 | 2.5 | 1.5 |
| (wt %) | | | | | | | | | | | | |
| CaO | 0.4 | 0.8 | 0.3 | 0.2 | 0.8 | 0.5 | 0.2 | 0.5 | 0.0 | 0.4 | 1.0 | 0.0 |
| (wt %) | | | | | | | | | | | | |
| BaO + SrO | 0.0 | 0.0 | 0.1 | 0.0 | 0.0 | 1.0 | 2.0 | 0.5 | 0.0 | 0.0 | 0.0 | 0.0 |
| (wt %) | | | | | | | | | | | | |
| ZnO | 0.0 | 0.0 | 0.0 | 0.0 | 0.0 | 0.0 | 0.5 | 0.0 | 0.0 | 0.0 | 0.0 | 0.0 |
| (wt %) | | | | | | | | | | | | |
| Cl₂ (wt %) | 0.1 | 0.1 | 0.1 | 0.1 | 0.1 | 0.1 | 0.1 | 0.1 | 0.1 | 0.1 | 0.1 | 0.2 |
| F₂ (wt %) | 0.1 | 0.1 | 0.1 | 0.1 | 0.1 | 0.1 | 0.1 | 0.1 | 0.1 | 0.1 | 0.1 | 0.0 |
| ZrO₂ | 0.0 | 0.1 | 0.3 | 0.1 | 0.1 | 0.5 | 0.1 | 0.1 | 0.1 | 0.1 | 0.1 | 0.0 |
| (wt %) | | | | | | | | | | | | |
| CTE | 38.8 | 38.7 | 39.7 | 39.5 | 38.5 | 35.8 | 36.0 | 37.7 | 39.3 | 41.1 | 41.9 | 34 |
| (×10⁻⁷ cm/cm/° C.) | | | | | | | | | | | | |

The present invention can be performed in a glass melter that is suitable for the chosen fabrication technique. Typically, the method of the present invention employs glass compositions exhibiting a softening point range from about 1442° F. (783.3° C.) to about 1530° F. (832.2° C.). Some examples follow.

Crucible Melting Method: A raw material batch formulated to yield approximately 2 pounds of the oxide composition shown as Example 1 in Table 2 was blended in a mixing jar and melted in a gas fired crucible furnace. The temperature of the melt was maintained at about 1500° C. without mechanical stirring until a significant portion of the gas bubbles and sand grains in the melt had been eliminated. The melt was then withdrawn from the crucible by hand and cooled to room temperature. The sample was cooled to room temperature at a slow rate in a box oven and the color produced was dark amber. This dark amber color was the expected result of the annealing method, as will be addressed in following paragraphs. The glass produced had a thermal expansion coefficient of 38.8×10⁻⁷ cm/cm/° C. Examples made that were not placed in a box oven had an aesthetically pleasing amber color.

Continuous unit furnace method: The preferred mode to manufacture this composition uses a state of the art electric hybrid furnace. The furnace employs a large number of molybdenum electrodes which fire across the furnace in multiple zones. Power is added or subtracted from-power zones to get the desired melting rate and glass fusion temperature. Natural gas fire above the melt adds to the total energy input as well as pre-melts the batch. High temperature AZS type refractory is used throughout the furnace, due to excessive wear present at the electrode areas. The melting area is required to be significantly greater than that of lower softening point glasses and is a direct function of the expected throughput of glass. Typical melting temperatures may be in excess of 1620° C. The oxide composition shown as Example 3 of Table 2 was obtained in a continuous unit furnace. The glass product had a thermal expansion coefficient measured at 39.7×10⁻⁷ cm/cm/° C. and was amber in color.

A vello tube forming system can be employed to fabricate drawn tubing. The vello forehearth is designed longer and wider than gob type forehearths used for blow molding; the additional size is required to uniformly cool to the glass to lower temperatures. Additional cooling is required, as the tube is drawn directly from the forehearth orifice. Typical installation includes one pair of refractory or precious metal stirrers to blend compositional and thermal striations in the glass. The forming equipment consists of an orifice ring and bell. The orifice ring shapes the outside diameter of the tubing while the bell determines the concentricity of the wall and pressurizes the tube. The tube is drawn continuously over 200 ft of rollers and cut as discrete sticks measuring 50 to 70 inches in length. The cut tube is packaged and transported to the transformation operation, where it is fed into a machine that fabricates glass vials from the cut tube.

Manufacture of the glass product makes it evident that conditions of the method impact the glass color. Shifts toward higher silican and boron (SiO₂, B₂O₃) content and longer cooling cycles result in darker glass. It is hypothesized that this is happening because the ratio of FeO to Fe₂O₃ is shifting in favor of FeO as a result of the method variables. It is further hypothesized that increasing melt temperature, and moving towards a more reduced system via batch make-up or burner operations will also cause the glass to be darker due to the same effect.

Thermal history of the formed article was found to significantly impact the color and opacification potential of the glass. Addressing primary cooling, the quicker the glass is cooled from viscous to solid, the lighter the color of the glass will be. By varying the rate at which the glass is cooled from viscous to solid, color ranges were obtained for the same sample that can be described as topaz, amber, and black. Topaz was obtained by cooling the glass very quickly, essentially quench cooling. Dark amber was obtained when a thick piece of glass was allowed to cool at its own rate.

Annealing the glass serves to darken the color, and as with primary cooling, prolonged annealing results in darker glass. Glass annealed in a box oven that was allowed to cool at furnace rate appeared black. Amber was obtained by annealing the article in a continuous tunnel oven that exposed the glass to annealing temperatures for only a few minutes.

In addition, the effect of heat treat on an article appears to be cumulative. If the article's thermal history reflects that of slow cooling and prolonged annealing, the sample will opacify if it is again reheated to elevated temperatures. The thermal history of the article, i.e. the cumulative effect of primary cooling and any reheats, must be balanced to produce an amber glass that is visibly desirable. Failure to do so may result in an article that is not dark enough to meet compendial requirements, an article that is undesirable because it is visually too dark, or an article that exhibits opacification.

Most pharmaceutical containers produced from the product of this invention must meet the industry standard tests for light protection. The applicable standard depends on the target market. The USP and the JP (Japanese Pharmacopoeia) are two industry standards that may be required for the formed containers.

The 26^{th} Edition of the USP specifies that percent transmission (% T) between 290 nm-450 nm for parenteral containers shall not exceed the specified value, ranging from 10% to 50% depending on container type and volume. Typical wall weights for containers can vary from 0.5 mm to 4.5 mm. The above parameters roughly place the operating window for % T normalized to 1 mm thickness at 450 nm (450T) at approximately 0-75% transmission. The 450T necessary to meet USP requirements will be determined by the situational combination of container type, capacity and wall thickness. In addition, annealing conditions will have an effect on color, and prolonged annealing cycles will generally result in lower % T at wavelengths of 290 nm-450 nm. A combination of the specifications and process effects must be considered when selecting the amount of iron oxide and titanium oxide colorants during manufacture of this invention. For illustration, Table 3 presents 450T values obtained under the stated conditions. Although there is a significant difference in the amount of light passing through these iterations of the present invention, both are capable of making a container that meets USP requirements.

TABLE 3

| | Example A | Example B |
|---|---|---|
| Fe₂O₃ (wt %) | 0.8% | 1.2% |
| TiO₂ (wt %) | 0.9% | 3.0% |
| 450T, unannealed | 47.8% | 3.5% |
| 450T, commercial anneal | 44.0% | 0.5% |

In the case that a container fabricated from this invention is intended for the Japanese market, alternate light transmission specifications must be met. The JP requirements for light transmission are: % T obtained between 290 nm-450 nm is not to exceed 50%, and between 590 nm-610 nm is not to be less than 60% for wall thickness less than 1.0 mm and not to be less than 45% for wall thickness exceeding 1.0 mm. Meeting he JP minimum % T in the 590 nm-610 nm range may preclude compliance with USP % T requirements in the 290 nm-450 nm range. If the packager wishes to distribute the same pharmaceutical product in both of these markets, compliance with both light transmission specifications negates the necessity for use of two package systems. Table 4 presents two iterations of the invention that meet both USP and JP light transmission requirements at the same time. These examples were commercially annealed.

TABLE 4

| | Example X | Example Y |
|---|---|---|
| Wall thickness | 0.90 mm | 1.08 mm |
| JP 290-450 nm % T | 50% max | 50% max |
| specification | | |
| 290-450 max % T | 47.4% | 25.9% |
| measured | | |
| JP 590-610 nm % T | 60% min | 45% min |
| specification | | |
| 590-610 min % T | 70.7% | 55.5% |
| measured | | |
| JP Compliance | Pass | Pass |
| USP compliance - | Flame seal containers | Flame seal containers up |
| up to measured | 1 ml | to 20 ml |
| USP/JP overlap - | Flame seal containers | Flame seal containers up |
| up to capability | 20 ml | to 20 ml |
| | | Closure seal containers up |
| | | to 2 ml |

The preferred glass produced by the present invention must meet pharmaceutical industry standards for resistance to hydrolytic attack. The glass formulation of the present invention meets the hydrolytic resistance requirements for Type I glass as set forth in the USP 26^{th} Edition. Specifically, the glass meets the requirement that a powdered glass titration limit does not exceed 1.0 ml of 0.02 N H₂SO₄. The range of typical values for this invention should be from about 0.4 to about 0.8 ml of 0.02N H₂SO₄.

The glass may be further fabricated using a method acceptable for manufacture of the desired glass article. Such articles include, but are not limited to, light protective containers, drawn tubes intended for conversion into pharmaceutical packages such as vials, ampoules or syringes, and blow molded containers.

Although the invention is illustrated and described herein with reference to specific embodiments, the invention is not intended to be limited to the details shown. Rather, various modifications may be made in the details within the scope and range of equivalents of the claims and without departing from the invention.

1. A method of making an amber borosilicate glass having a thermal expansion coefficient within the range of 29×10⁻⁷ cm/cm/° C. to 48×10⁻⁷ cm/cm/° C., the method comprising the steps of: forming a substantially homogeneous melt comprising in weight %, 70.0-80.0% SiO₂; 10.0-15.0% B₂O₃; 1.0-5.0% Al₂O₃; 0.0-7.0% Na₂O; 0.0-8.0% K₂O; 0.1-2.0% Fe₂O₃; 0.1-5.0% TiO₂; 0.0-4.0% CaO; 0.0-4.0% MgO; 0.0-4.0% BaO and SrO combined; 0.0-1.0% ZnO; 0.0-1.0% Cl₂; 0.0-1.0% F₂; and 0.0-1.0% ZrO₂; refining the melt to remove substantially all gas bubbles from the melt; and cooling the melt to form amber glass.

2. The method of claim 1 wherein the melt comprises, in weight %, 73.0-79.0% SiO₂; 11.0-13.0% B₂O₃; 3.0-5.0% Al₂O₃; 2.0-3.8% Na₂O; 0.0-2.0% K₂O; 0.0-1.5% Fe₂O₃; 0.5-3.0% TiO₂; 0.0-1.0% CaO; 0.0-1.0% MgO; 0.0-2.0% BaO and SrO combined; 0.0-0.5% ZnO; 0.0-0.5% Cl₂; 0.0-0.5% F₂; and 0.0-0.5% ZrO₂.

3. The method of claim 1 wherein the melt comprises, in weight %, 76.0-78.0% SiO₂; 11.5-12.5% B₂O₃; 3.0-4.0% Al₂O₃; 3.0-3.7% Na₂O; 0.0-1.0% K₂O; 1.0-1.5% Fe₂O₃; 1.5-2.5% TiO₂; 0.2-0.8% CaO; 0.0-0.2% MgO; 0.0-0.2% Cl₂; 0.0-0.2% F₂; and 0.0-0.2% ZrO₂.

4. The method of claim 1 wherein the melt comprises, in weight %, 76.7% SiO₂; 11.7% B₂O₃; 3.2% Al₂O₃; 3.7% Na₂O; 0.6% K₂O; 1.2% Fe₂O₃; 2.1% TiO₂; 0.4% CaO; 0.1% Cl₂; and 0.1% F₂.

5. The method of claim 1 wherein the TiO₂ level in the melt is 1.5-2.5 weight %.

6. The method of claim 1 wherein the Fe₂O₃ level in the melt is 1.0-1.5 weight %.

7. The method of claim 1 further comprising forming the amber glass into a light protective container.

8. The method of claim 1 further comprising forming the amber glass into a tube.

9. The method of claim 1 further comprising blow molding the amber glass into the shape of a container.
